(19) United States
(12) Patent Application Publication
(10) Pub. No.: US 2001/0017537 A1
(43) Pub. Date: Aug. 30, 2001

(54) Voltage regulator provided with a current limiter

(76) Inventor: Roland Albert Bertha Antheunis, Nijmegen (NL)

Correspondence Address: Corporate Patent Counsel, U.S. Philips Corporation, 580 White Plains Road, Tarrytown, NY, 10591, US

(21) Appl. No.: 09/741,723

(22) Filed: Dec. 19, 2000

(30) Foreign Application Priority Data
Dec. 21, 1999 (EP) 99204453.7

(51) Int. Cl. G05F 3/04

(52) U.S. Cl. 323/312

(57) ABSTRACT

A voltage regulator for converting an input voltage (Vᵢ) into an output voltage (Vₒ). The input voltage may be burdened with a ripple. The output voltage (Vₒ) supplied by the voltage regulator is virtually free from ripple. The voltage regulator comprises an input terminal (1) for receiving the input voltage (Vᵢ), an output terminal for supplying the output voltage (Vₒ) in response to the input voltage (Vᵢ), and current limiting means for limiting the maximum absolute value of an output current (Iₒ) taken from the output terminal (2). The current limiting means comprise a field effect transistor (T_{CL}). The voltage regulator further comprises a first current mirror (CM₁) comprising transistors (T₁₁, T₁₂), a second current mirror (CM₂) comprising transistors (T₁₃, T₁₄), and a third current mirror comprising transistors (T₁₅, T₁₆). In a typical operation, the field effect transistor (T_{CL}) is in the linear region and thus behaves like a resistance. With an increasing output current (Iₒ), the current through the field effect transistor (T_{CL}) also increases, and the voltage between the drain and the source of the field effect transistor (T_{CL}) increases. When the voltage between the drain and the source of the field effect transistor (T_{CL}) has exceeded a certain level, the field effect transistor (T_{CL}) enters its saturation region and accordingly behaves like a constant-current source. As a consequence the output current (Iₒ) can no longer rise.

The invention relates to a voltage regulator for converting an input voltage, which may be affected by a ripple, into an output voltage which is substantially not affected by a ripple, comprising an input terminal for receiving the input voltage, an output terminal for supplying the output voltage in response to the input voltage, and current limiting means for limiting the maximum absolute value of an output current supplied from the output terminal.

Such a voltage regulator is known from Japanese patent abstract JP 2-136029 A. The known voltage regulator comprises a current mirror with an input and an output and, a bipolar transistor whose base is connected to the current mirror and whose emitter forms the output terminal of the voltage regulator. The known voltage regulator further comprises a voltage divider which consists of two resistors connected in series. The voltage divider is connected between the emitter of the bipolar transistor and a supply voltage terminal. The known voltage regulator further comprises a comparator, a first current source which supplies a comparatively small current, and a second current source which supplies a comparatively large current. A switch is connected in series with the second current source. The comparator is connected by a first input to the common junction point of the two resistors connected in series, and is connected by a second input to a reference voltage source, and is connected by an output to a control electrode of the switch. In a normal operational state of the voltage regulator, the switch is in the conducting state. The current supplied to the input of the current mirror in that case is determined by the sum of the currents supplied by the first and the second current source. This current is delivered from the output of the current mirror to the base of the bipolar transistor. The bipolar transistor amplifies this current and delivers the amplified current to the voltage divider. As the current through the voltage divider rises, the voltage at the first input of the comparator will become greater than the voltage at the second input of the comparator at a given moment. As a result of this, the voltage at the output of the comparator changes, such that the switch switches from the conducting state to a non-conducting state. In this state, the current supplied to the input of the current mirror is dependent on the first current source only. As a result, the current supplied from the output of the current mirror is reduced, so that the current supplied from the emitter of the bipolar transistor to the voltage divider is limited.

A disadvantage of the known voltage regulator is that the current limitation is achieved in a comparatively complicated manner.

It is an object of the invention to provide a voltage regulator which reduces the above mentioned disadvantage.

According to the invention, the voltage regulator mentioned in the opening paragraph is for this purpose characterized in that the current limiting means comprise a current limiting transistor with a main current path, and in that the current limiting means are designed such that, if the voltage across the main current path is higher than a given threshold voltage of the current limiting transistor, at which the current limiting transistor acts as a current source, the maximum absolute value of the output current is limited.

The invention is based on the recognition that the transistor is in its linear operational range as long as a voltage across the main current path of a transistor lies below a certain limit, so that the transistor behaves as a resistor, and on the recognition that, as the voltage across the main current path rises, there comes a moment when the voltage across the main current path exceeds said limit, so that the transistor starts behaving as a current source. The transistor thus acts as a current limiting transistor. The current limiting transistor may be constructed, for example, with a field effect transistor. When the drain-source voltage of the field effect transistor is smaller than the difference between the gate-source voltage and the so-called threshold voltage Vₜ, the field effect transistor is in its linear operational range. When the drain-source voltage of the field effect transistor is higher than the difference between the gate-source voltage and the so-called threshold voltage Vt, the field effect transistor is in its saturation range, wherein the field effect transistor acts as a constant-current source. The current limiting transistor may alternatively be constructed with a bipolar transistor. When the collector-emitter voltage of the bipolar transistor is below the so-called saturation voltage, the transistor is in saturation and behaves more or less as a resistor. When the collector-emitter voltage of the bipolar transistor is greater than the so-called saturation voltage, the bipolar transistor is not in the saturated state. The bipolar transistor then acts as a constant-current source.

Further advantageous embodiments of the invention are defined in claims 2 and 3.

The invention will be explained in more detail with reference to the attached drawing, in which:

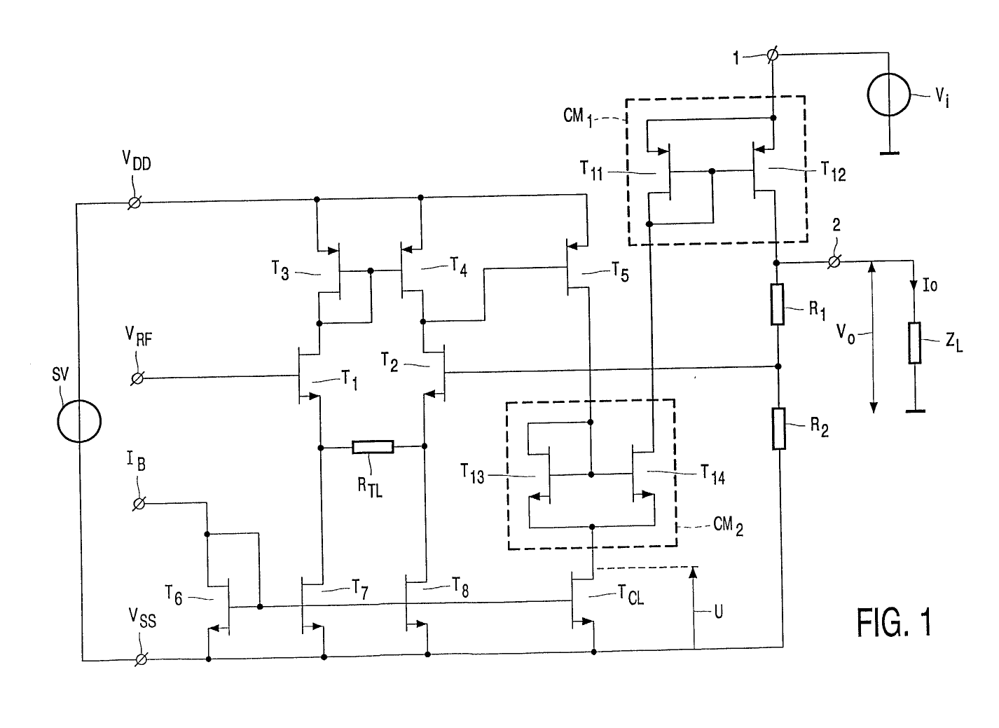

FIG. 1 is a circuit diagram of a first embodiment of a voltage regulator according to the invention; and

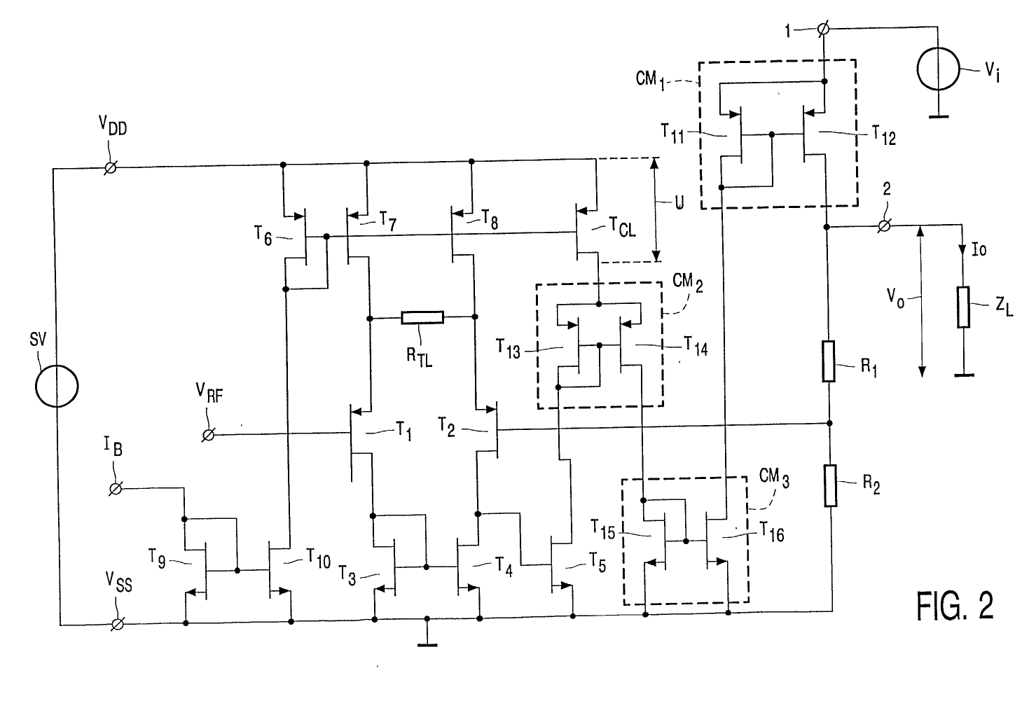

FIG. 2 is a circuit diagram of a second embodiment of a voltage regulator according to the invention.

Corresponding components or elements have been given the same reference symbols in these Figures.

FIG. 1 shows a circuit diagram of a first embodiment of a voltage regulator according to the invention. The voltage regulator is supplied from a supply voltage source SV which is connected between a supply voltage terminal V_{SS} and a further supply voltage terminal V_{DD}. The voltage regulator has an input terminal 1 for receiving an input voltage Vᵢ and an output terminal 2 for supplying an output voltage Vₒ in response to the input voltage Vᵢ. A load Z_{L} is connected between the output terminal 2 and the supply voltage terminal V_{SS}. An output current Iₒ supplied from the output terminal 2 flows through the load Z_{L}. The voltage regulator further comprises a first current mirror CM₁ with field effect transistors T₁₁ and T₁₂, a second current mirror CM₂ with field effect transistors T₁₃ and T₁₄, field effect transistors T₁ to T₈, current limiting field effect transistor T_{CL}, tail resistor R_{TL}, and a voltage divider which is implemented with a series arrangement of a resistor R₁ and a resistor R₂, which series arrangement is connected between the output terminal 2 and the supply voltage terminal V_{SS}. The gates of transistors T₁₁ and T₁₂ and the drain of transistor T₁₁ are interconnected and form the input of the first current mirror CM₁. The drain of transistor T₁₂ forms the output of the first current mirror CM₁ and is connected to the output terminal 2. The sources of transistors T₁₁ and T₁₂ are interconnected and form a reference connection point of the first current mirror CM₁ and are connected to the input terminal 1. The gates of transistors T₁₃ and T₁₄ and the drain of transistor T₁₃ are interconnected and form the input of the second current mirror CM₂. The drain of transistor T₁₄ forms the output of the second current mirror CM₂ and is connected to the input of the first current mirror CM₁. The sources of transistors T₁₃ and T₁₄ are interconnected and form a reference connection point of the second current mirror CM₂. The sources of transistors T₆, T₇, T₈ and of current limiting transistor T_{CL} are connected to the supply voltage terminal V_{SS}. The drain of transistor T₆ and the gates of transistors T₆, T₇, T₈ and of the current limiting transistor T_{CL} are connected to a current reference terminal T₁₃. The drain of current limiting transistor TCL is connected to the reference connection point of the second current mirror CM₂. The sources of transistors T₃, T₄, and T₅ are connected to the further supply voltage terminal V_{DD}. The drain of transistor T₃ and the gates of transistors T₃ and T₄ are connected to the drain of transistor T₁. The gate of transistor T₁ is connected to a voltage reference terminal V_{RF}. The source of transistor T₁ is connected to the drain of transistor T₇. The drain of transistor T₄ and the gate of transistor T₅ are connected to the drain of transistor T₂. The source of transistor T₂ is connected to the drain of transistor T₈. The tail resistor RTL is connected between the source of transistor T₁ and the source of transistor T₂. The gate of transistor T₂ is connected to the common junction point of the resistors R₁ and R₂.

The circuit operates as follows. The voltage across the resistor R₂ is controlled so as to be equal to the reference voltage which is offered between the voltage reference terminal V_{RF} and the supply voltage terminal V_{SS}. As a result of this, the output voltage Vₒ between the output terminal 2 and the supply voltage terminal V_{SS} is equal to said reference voltage multiplied by the sum of the values of the resistors R₁ and R₂ and divided by the value of resistor R₂. Since the reference voltage is free from ripple, the output voltage Vₒ is also free from ripple. The ripple which may be present on the input voltage Vi accordingly does not extend itself to the output voltage Vₒ. For an optimum operation, however, the input voltage Vᵢ should always be greater than the output voltage Vₒ. As long as the voltage regulator is in a normal operating condition, i.e. no current limitation takes place, the output current Iₒ will rise as the impedance of the load Z_{L} decreases. In this normal operating condition, the current limiting transistor T_{CL} is in its linear operating range. The current limiting transistor T_{CL} thus acts as a resistor. As the output current Iₒ rises, there will come a moment when the voltage U between the drain and the source of the current limiting transistor T_{CL} becomes so great that the current limiting transistor T_{CL} changes from its linear operating range to its so-called saturation region. The current limiting transistor T_{CL} acts as a constant current source as a result of this. The current which is supplied by transistor T₅ cannot be controlled upwards any further because in that case the potential at the drain of transistor T₅ will rise quickly, which will render the source-drain voltage of transistor T₅ so low that the transistor T₅ changes from the saturation region to the linear operating region. Since the current to the input of the second current mirror CM₂ is limited thereby, the output current Iₒ is also limited via the second current mirror CM₂ and via the first current mirror CM₁. The tail resistor R_{TL} serves to improve the stability of the voltage regulator, so that there is no risk of undesirable oscillations occurring.

FIG. 2 shows a circuit diagram of a second embodiment of a voltage regulator according to the invention. An advantage of this second embodiment over the first embodiment of FIG. 1 is that the reference voltage between the voltage reference terminal V_{RF} and the supply voltage terminal V_{SS} may be chosen to be lower. For this purpose, all transistors having a p-conductivity type are replaced by transistors having an n-conductivity type, except for transistors T₁₁ and T₁₂, and all transistors having an n-conductivity type are replaced by transistors having a p-conductivity type. A third current mirror CM₃ is added, composed with field effect transistors Tls and T₁₆. The drain of transistor T₁₅ and the gates of transistors T₁₅ and T₁₆ are interconnected and form the input of the third current mirror CM₃, which is connected to the output of the second current mirror CM₂. The drain of transistor T₁₆ forms the output of the third current mirror CM₃ and is connected to the input of the first current mirror CM₁. The sources of transistors T₁₅ and T₁₆ are interconnected and form a reference connection terminal of the third current mirror CM₃, which is connected to the supply voltage terminal V_{SS} of the voltage regulator.

The operation of the circuit of FIG. 2 is equivalent to the operation of the circuit of FIG. 1.

A further advantage of a voltage regulator according to the invention is that the output voltage Vₒ can be substantially equal to the input voltage Vᵢ.

The differential pair T₁, T₂ may be replaced by some other type of differential stage, for example a cascoded differential stage. The voltage regulator may either be constructed from discrete components or be implemented in an integrated circuit. The voltage regulator may be constructed with field effect transistors as well as with bipolar transistors. A combination of field effect transistors and bipolar transistors may also be used. It is also possible to replace all p-type transistors with n-type transistors, provided all n-type transistors are replaced with p-type transistors at the same time.

1. A voltage regulator for converting an input voltage (Vᵢ), which may be affected by a ripple, into an output voltage (Vₒ) which is substantially not affected by a ripple, comprising an input terminal (1) for receiving the input voltage(Vᵢ), an output terminal (2) for supplying the output voltage (Vₒ) in response to the input voltage (Vᵢ), and current limiting means for limiting the maximum absolute value of an output current (Iₒ) supplied from the output terminal (2), characterized in that the current limiting means comprise a current limiting transistor (T_{CL}) with a main current path, and in that the current limiting means are designed such that, if the voltage (U) across the main current path is higher than a given threshold voltage of the current limiting transistor(T_{CL}), at which the current limiting transistor (T_{CL}) acts as a current source, the maximum absolute value of the output current (Iₒ) is limited.

2. A voltage regulator as claimed in claim 1, characterized in that the current limiting means further comprise a first current mirror (CM₁) with an input, an output coupled to the output terminal (2) and a reference connection point which is coupled to the input terminal (1); and a second current mirror (CM₂) with an input, an output coupled to the input of the first current mirror (CM₁), and a reference connection point, and in that the main current path of the current limiting transistor (T_{CL}) is connected in series with the reference connection point of the second current mirror (CM₂) and a supply voltage terminal (V_{SS}) of the voltage regulator.

3. A voltage regulator as claimed in claim 1, characterized in that the current limiting means further comprise a first current mirror (CM₁) with an input, an output coupled to the output terminal (2) and a reference connection point which is coupled to the input terminal (1); a second current mirror (CM₂) with an input, an output, and a reference connection point; and a third current mirror (CM₃) with an input coupled to the output of the second current mirror (CM₂), an output coupled to the input of the first current mirror (CM₁), and a reference connection point which is coupled to the supply voltage terminal (V_{SS}) of the voltage regulator; and in that the current limiting transistor (T_{CL}) is connected in series with the reference connection point of the second current mirror (CM₂) and a further supply voltage terminal (V_{DD}) of the voltage regulator.
